(19) United States
(12) Patent Application Publication
(10) Pub. No.: US 2013/0215270 A1
(43) Pub. Date: Aug. 22, 2013

(54) OBJECT DETECTION APPARATUS

(71) Applicant: Fujitsu Ten Limited, (US)

(72) Inventors: Kimitaka MURASHITA, Kawasaki (JP); Tetsuo YAMAMOTO, Kobe-shi (JP)

(73) Assignee: FUJITSU TEN LIMITED, Kobe-shi (JP)

(21) Appl. No.: 13/668,522

(22) Filed: Nov. 5, 2012

(30) Foreign Application Priority Data
Feb. 16, 2012 (JP) 2012-031627

(51) Int. Cl. G06K 9/62; H04N 7/18

(52) U.S. Cl. 348/148; 382/103; 348/E07.085

(57) ABSTRACT

In an object detection apparatus, an image obtaining part obtains, continuously in time, captured images captured by a vehicle-mounted camera capturing images of a vicinity of a host vehicle. A first detector detects an object by using the plurality of captured images obtained by the obtaining part at different time points. The first detector stores, as a template image, an area relating to the object detected by the first detector and included in one of the plurality of captured images that have been processed, in a memory. Moreover, a second detector detects an object by searching for a correlation area, having a correlation with the template image, included in a single captured image obtained by the image obtaining part.

### BACKGROUND OF THE INVENTION

1. Field of the Invention

The invention relates to a technology that detects an object moving in a vicinity of a vehicle.

2. Description of the Background Art

Conventionally, object detection methods, such as a frame correlation method and a pattern recognition method, have been proposed as a method for detecting an object moving in a vicinity of a vehicle based on a captured image obtained by a camera disposed on the vehicle.

As one of the frame correlation methods, for example, an optical flow method is well known. The optical flow method extracts feature points from each of a plurality of captured images (frames) and detects an object based on a direction of optical flows that indicate motions of the feature points among the plurality of captured images.

Moreover, as one of the pattern recognition methods, for example, a template matching method is well known. In the template matching method, a template image showing an external appearance of an object to be detected (detection target object) is prepared as a pattern beforehand. Then an object is detected by searching for an area similar to the template image from one captured image.

The frame correlation method is preferable in terms of a fact that a moving object can be detected by a relatively small amount of computation. However, the frame correlation method has a problem in that it is difficult to detect an object under a condition, such as when the vehicle travels at a relatively high speed.

On the other hand, the pattern recognition method can detect an object from one captured image. Therefore, it is preferable in terms of a fact that an object can be detected regardless of a traveling state of the vehicle. However, the pattern recognition method has a problem in that a pattern of a detection target object is required to be prepared beforehand and that an object of which a pattern has not been prepared cannot be detected.

### SUMMARY OF THE INVENTION

According to one aspect of the invention, an object detection apparatus detects an object moving in a vicinity of a vehicle. The object detection apparatus includes: an obtaining part that obtains a captured image of the vicinity of the vehicle; a first detector that detects the object by using a plurality of the captured images obtained by the obtaining part at different time points; a memory that stores, as a reference image, an area relating to the object detected by the first detector and included in one of the plurality of captured images that have been used by the first detector; and a second detector that detects the object by searching for a correlation area, having a correlation with the reference image, included in a single captured image obtained by the obtaining part.

The second detector detects the object by using the area relating to the object detected by the first detector, as the reference image, and by searching for the correlation area, having the correlation with the reference image, included in the captured image. Therefore, an object can be detected even under a situation where it is difficult to detect the object by a method using the first detector.

Moreover, according to another aspect of the invention, the object detection apparatus further includes a controller that selectively enables one of the first detector and the second detector in accordance with a state of the vehicle.

An object can be detected even when the vehicle is in a state where it is difficult to detect the object by the method using the first detector, because the controller selectively enables one of the first detector and the second detector in accordance with the state of the vehicle.

Furthermore, according to another aspect of the invention, the controller enables the first detector when a speed of the vehicle is below a threshold speed and enables the second detector when the speed of the vehicle is at or above the threshold speed.

An object can be detected even during traveling of the vehicle during which it is difficult to detect the object by the method using the first detector, because the controller enables the second detector when the speed of the vehicle is at or above the threshold speed.

Therefore, an object of the invention is to detect an object even under a situation where it is difficult to detect the object by the method using the first detector.

These and other objects, features, aspects and advantages of the invention will become more apparent from the following detailed description of the invention when taken in conjunction with the accompanying drawings.

### BRIEF DESCRIPTION OF THE DRAWINGS

FIG. 1 is a diagram illustrating an outline configuration of an object detection system;

FIG. 2 illustrates an exemplary case where the object detection system is used;

FIG. 3 is a diagram illustrating a configuration of an object detector in a first embodiment;

FIG. 4 illustrates an example of a captured image obtained by a vehicle-mounted camera;

FIG. 5 illustrates an example of a captured image obtained by a vehicle-mounted camera;

FIG. 6 illustrates an example of a captured image obtained by a vehicle-mounted camera;

FIG. 7 illustrates an example of a captured image superimposed with a detection result;

FIG. 8 illustrates an outline of an optical flow method;

FIG. 9 illustrates an outline of a template matching method;

FIG. 10 is a diagram illustrating a relation between a host vehicle and objects in a vicinity of the host vehicle;

FIG. 11 is a flowchart illustrating an object detection process in the first embodiment;

FIG. 12 is a diagram illustrating detection areas set in a captured image;

FIG. 13 is a diagram illustrating a search range set in a captured image;

FIG. 14 is a diagram illustrating sizes of a template image and the search range;

FIG. 15 is a flowchart illustrating an object detection process in a second embodiment;

FIG. 16 is a diagram illustrating a configuration of an object detector in a third embodiment; and

FIG. 17 is a flowchart illustrating an object detection process in the third embodiment.

### DESCRIPTION OF THE EMBODIMENTS

Embodiments of the invention are hereinafter explained with reference to the drawings.

### 1. First Embodiment

### 1-1. Entire Configuration

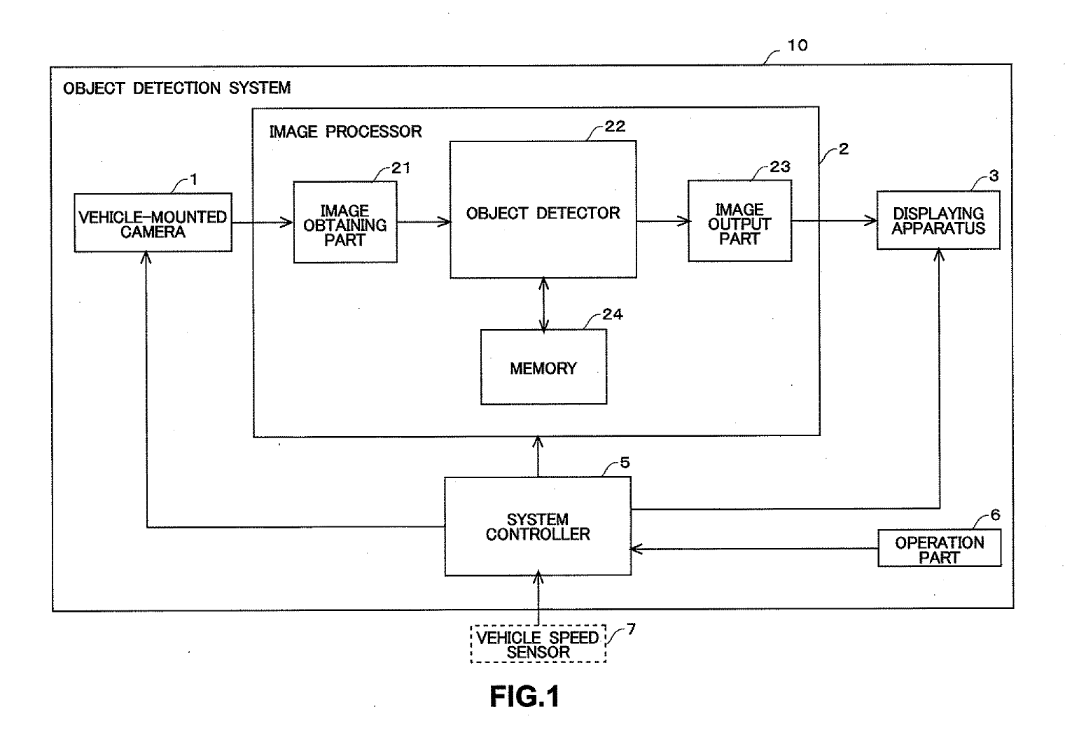

FIG. 1 is a diagram illustrating an outline configuration of an object detection system 10. in this embodiment. The object detection system 10 has a function of detecting an object moving in a vicinity of a vehicle, such as a car, on which the object detection system 10 is mounted and of showing a detection result to a user if the object detection system 10 has detected the object. An example of the object detection system 10 is a blind corner monitoring system that displays an image of an area in front of a vehicle. The vehicle on which the object detection system 10 is mounted is hereinafter referred to as a “host vehicle.”

The object detection system 10 includes a vehicle-mounted camera 1 that obtains a captured image by capturing an image of the vicinity of the host vehicle, an image processor 2 that processes the captured image obtained by the vehicle-mounted camera 1, and a displaying apparatus 3 that displays the captured image processed by the image processor 2. The vehicle-mounted camera 1 is a front camera that captures an image of the area in front of the host vehicle in a predetermined cycle (e.g. 1/30 sec.). Moreover, the displaying apparatus 3 is a display that is disposed in a location in a cabin of the host vehicle where a user (mainly a driver) can see the displaying apparatus 3 and that displays a variety of information.

Moreover, the object detection system 10 includes a system controller 5 that comprehensively controls whole of the object detection system 10 and an operation part 6 that the user can operate. The system controller 5 starts the vehicle-mounted camera 1, the image processor 2, and the displaying apparatus 3 in response to a user operation to the operation part 6, and causes the displaying apparatus 3 to display the captured image indicating a situation of the area in front of the host vehicle. Thus, the user can confirm the situation in front of the host vehicle in substantially real time by operating the operation part 6 at a time when the user desires to confirm the situation, such as when the host vehicle is approaching a blind intersection.

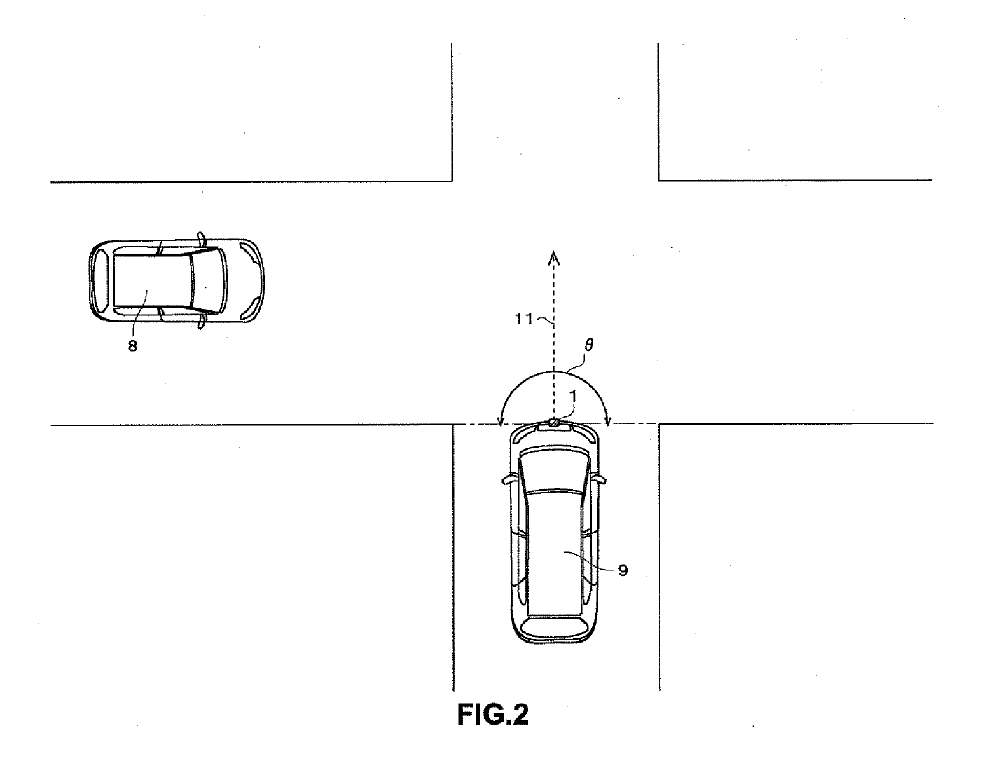

FIG. 2 illustrates an exemplary case where the object detection system 10 is used. As shown in FIG. 2, the vehicle-mounted camera 1 is disposed on a front end of the host vehicle 9, having an optical axis 11 in a direction in which the host vehicle 9 travels. A fisheye lens is adopted for a lens of the vehicle-mounted camera 1. The vehicle-mounted camera 1 has an angle of view 0 of 180 degrees or more. Therefore, by using the vehicle-mounted camera 1, it is possible to capture an image of an area in a horizontal direction of 180 degrees or more in front of the host vehicle 9. As shown in FIG. 2, when the host vehicle 9 is approaching an intersection, the vehicle-mounted camera 1 is capable of capturing an object, such as another vehicle 8 and a pedestrian, existing in a left front or a right front of the host vehicle 9.

With reference back to FIG. 1, the image processor 2 detects an object approaching the host vehicle, based on the captured image obtained by the vehicle-mounted camera 1 as mentioned above. The image processor 2 includes an image obtaining part 21, an object detector 22, an image output part 23, and a memory 24.

The image obtaining part 21 obtains an analog captured image in a predetermined cycle (e.g. 1/30 sec.) from the vehicle-mounted camera 1 continuously in time, and converts the obtained analog captured image into a digital captured image (AID conversion). One captured image processed by the image obtaining part 21 constitutes one frame of an image signal.

An example of the object detector 22 is a hardware circuit, such as LSI having an image processing function. The object detector 22 detects an object based on the captured image (frame) obtained by the image obtaining part 21 in the predetermined cycle. When having detected the object, the object detector 22 superimposes information relating to the detected object on the captured image.

The image output part 23 outputs the captured image processed by the object detector 22, to the displaying apparatus 3. Thus, the captured image including the information relating to the detected object is displayed on the displaying apparatus 3.

The memory 24 stores a variety of data used for an image process implemented by the object detector 22.

A vehicle speed signal indicating a speed of the host vehicle is input into the image processor 2 via the system controller 5 from a vehicle speed sensor 7 provided in the host vehicle. The object detector 22 changes object detection methods based on the vehicle speed signal.

### 1-2. Object Detector

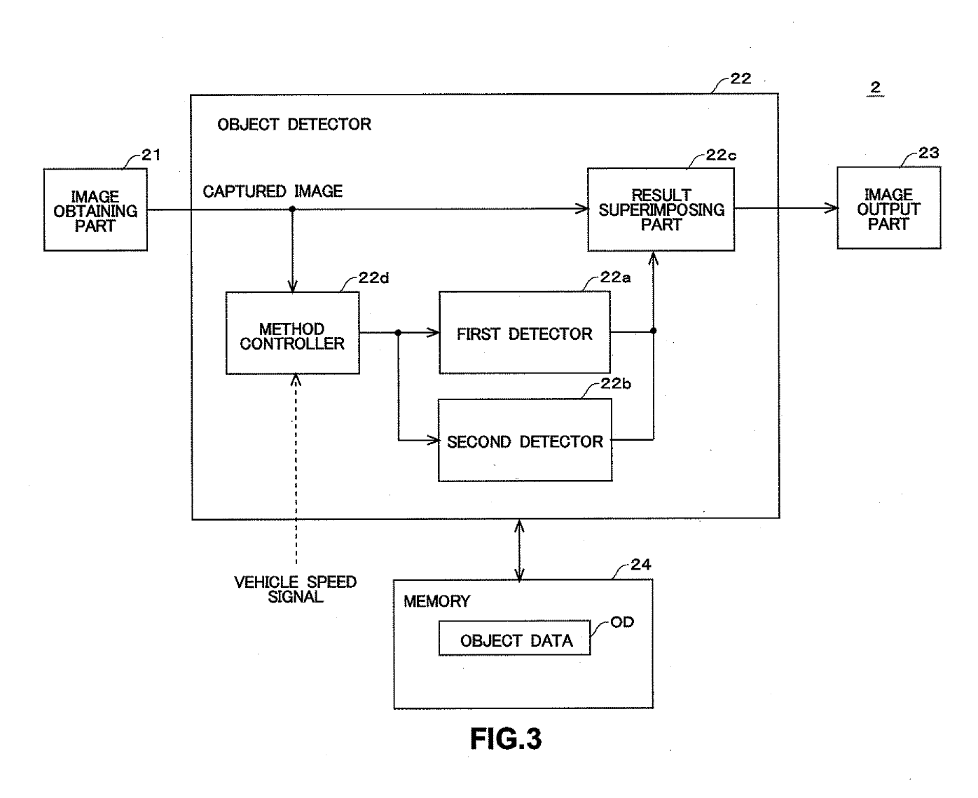

FIG. 3 is a diagram illustrating a configuration of the object detector 22 in detail. As shown in FIG. 3, the object detector 22 includes a first detector 22a, a second detector 22b, a result superimposing part 22c, and a method controller 22d. Those elements are a part of functions that the object detector 22 has.

Each of the first detector 22a and the second detector 22b detects an object based on the captured image. The first detector 22a detects an object in an object detection method different from a method implemented by the second detector 22b. The first detector 22a detects the object in an optical flow method that is one type of the frame correlation method for detecting the object by using a plurality of captured images (frames) each of which has been obtained at a different time point. On the other hand, the second detector 22b detects the object in a template matching method that is one type of the pattern recognition method for detecting the object by using one captured image (frame) and by searching the one captured image for a correlation area having a correlation with a reference image included in the one captured image.

The method controller 22d selectively enables one of either the first detector 22a or the second detector 22b. The method controller 22d determines whether the host vehicle is traveling or stopping, based on the vehicle speed signal input from an outside, and enables one of the first detector 22a and the second detector 22b, in accordance with the determined result. In other words, the method controller 22d changes the object detection method that the object detector 22 implements, in accordance with a traveling state of the host vehicle.

The result superimposing part 22c superimposes a detection result of the object detected by the first detector 22a or the second detector 22b, on the captured image. The result superimposing part 22c superimposes a mark indicating a direction in which the object exists.

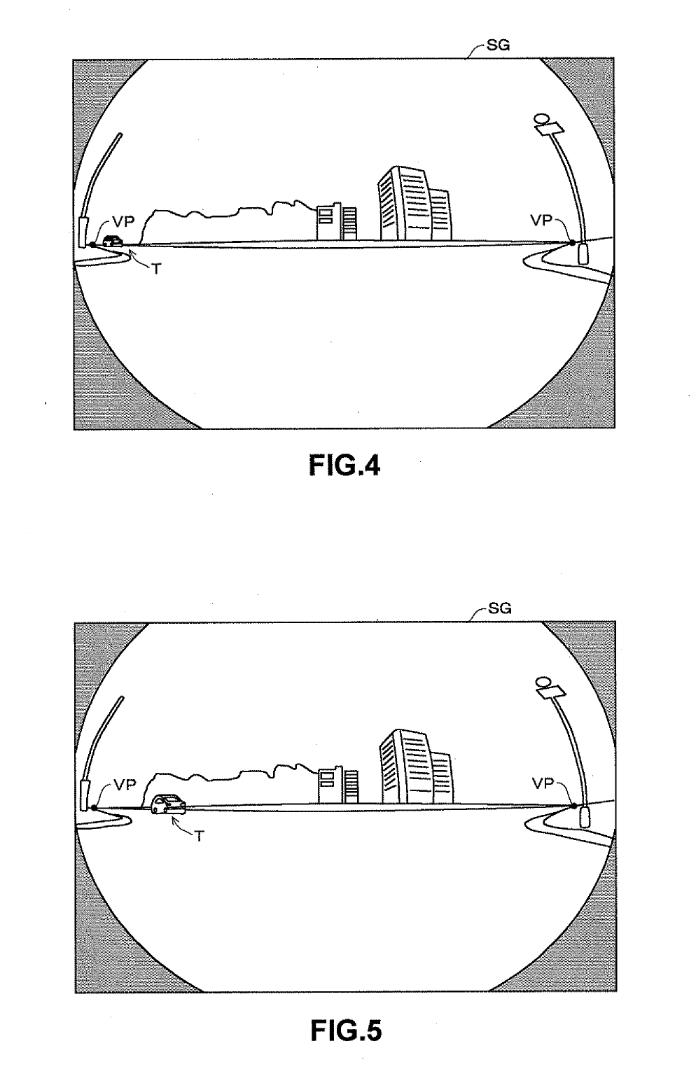

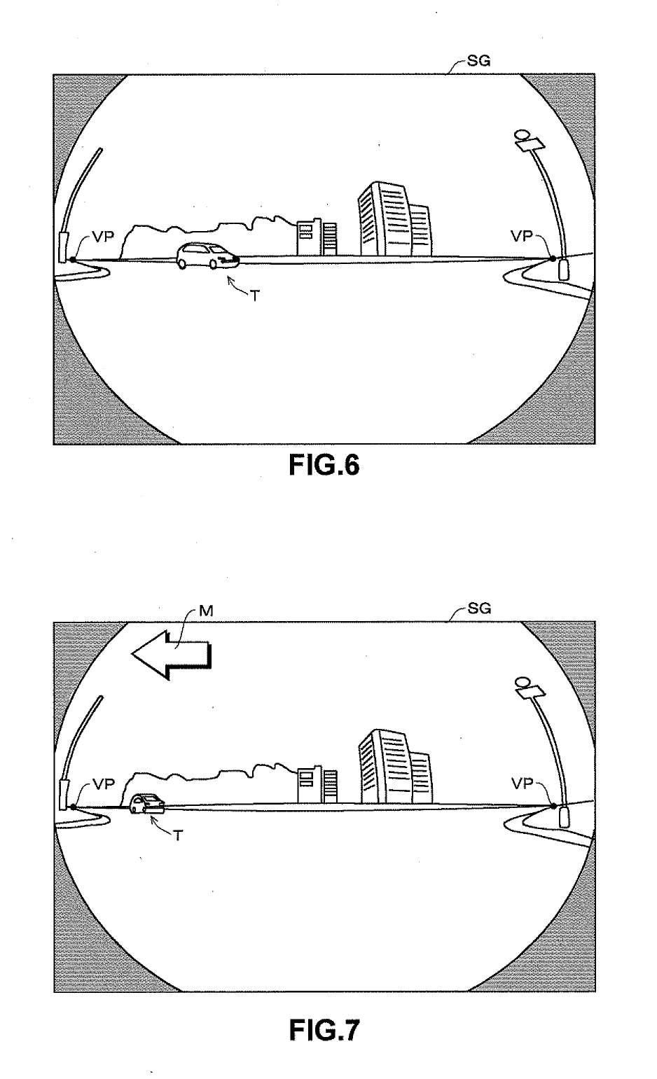

FIG. 4, FIG. 5 and FIG. 6 illustrate examples of the plurality of captured images SG captured in a time series by the vehicle-mounted camera 1. The captured image in FIG. 4 has been captured earliest, and the captured image in FIG. 6 has been captured latest. Each of the captured images SG in FIG. 4 to FIG. 6 includes an object image T of a same object approaching the host vehicle. The first detector 22a and the second detector 22b detect the object approaching the host vehicle, based on such a captured image SG. If the object has been detected in this process, the result superimposing part 22c superimposes a mark M indicating the direction in which the object exists, on the captured image SG, as shown in FIG. 7. The captured image SG like FIG. 7 is displayed on the displaying apparatus 3. Thus the user can easily understand the direction in which the object approaching the host vehicle exists.

Outlines of the optical flow method implemented by the first detector 22a and of the template matching method implemented by the second detector 22b are hereinafter explained individually.

### 1-2-1. Optical Flow Method

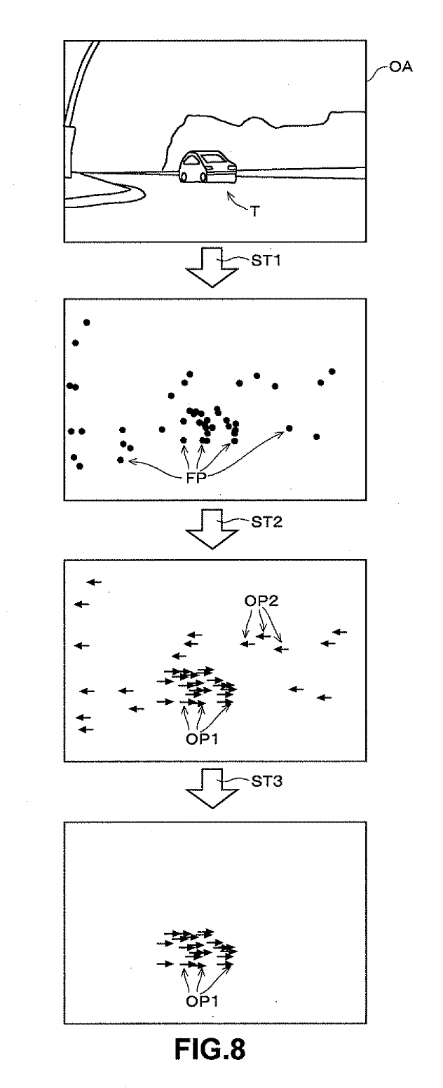

FIG. 8 illustrates an outline of the optical flow method. In the optical flow method, feature points FP are extracted from the plurality of captured images (frames) each of which is obtained at a different time point, and an object is detected based on directions of optical flows indicating motions of the feature points FP tracked through the plurality of captured images. A detection area OA shown in FIG. 8 is included in the captured image and is processed in the optical flow method.

The optical flow method first extracts the feature points FP (conspicuously detectable points) in the detection area OA in the captured image obtained most recently by use of a well-known method such as Harris operator (a step ST1). Thus plural points including corners (intersection points of edges) of the object image T are extracted as the feature points FP.

Next, the feature points FP extracted from the most recently captured image are caused to correspond to feature points FP extracted from a past captured image. The feature points FP in the past captured image are stored in the memory 24. Then the optical flows that are vectors indicating the motions of the feature points FP are derived based on individual positions of the two corresponding feature points FP (a step ST2).

There are two types of optical flows derived in the method described above: right-pointing optical flow OP1 and left-pointing optical flow OP2. As shown in FIG. 4 to FIG. 6, the object image T of the object approaching the host vehicle moves inward (a direction from a left or a right side of the captured image SG to a center area). On the other hand, an image of an object in the background stays still or moves outward (a direction from a center to the left or the right side of the captured image SG).

Therefore, only inward-moving optical flows are extracted as optical flows of an approaching object (a step ST3). Concretely, when the detection area OA is located in a left side area of the captured image, only the right-pointing optical flows OP1 are extracted. When the detection area OA is located in a right side area of the captured image, only the left-pointing optical flows OP2 are extracted. In FIG. 8, only the right-pointing optical flows OP1 are extracted.

Among the extracted optical flows OP1, optical flows OP1 locating close to each other are grouped. Such a group of the optical flows OP1 is detected as an object. Coordinate data of the group is used for coordinate data indicating a location of the object.

### 1-2-2. Template Matching Method

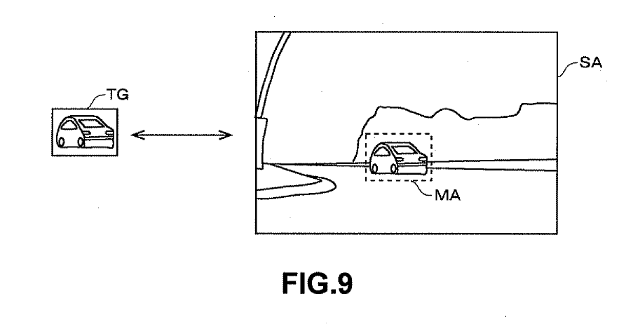

FIG. 9 illustrates an outline of the template matching method. In the template matching method, an object is detected by searching one captured image (frame) for a correlation area MA very similar to a template image TG, by using the template image TG showing an external appearance of the object as the reference image. A search range SA shown in FIG. 9 is included in the captured image and is processed in the template matching method.

First, the search range SA is scanned with reference to the template image TG to search for an area having a correlation with the template image TG. Concretely, in the search range SA, an evaluation area in a same size as the template image TG is selected. Then an evaluation value indicating a level of the correlation (a level of similarity) between the evaluation area and the template image TG is derived. A well-known evaluation value, such as sum of absolute differences (SAD) of pixel values or sum-of-squared differences (SSD) of pixel values, may be used as the evaluation value. Then, the evaluation area is shifted slightly to search the entire search range SA while such an evaluation value is repeatedly derived.

If evaluation areas of which evaluation values are lower than a predetermined threshold have been found in the scan, among such evaluation areas, an evaluation area of which evaluation value is the lowest is detected as the object. In other words, the correlation area MA having a highest correlation with the template image TG is detected as the object. Coordinate data of the correlation area MA having the highest correlation is used as the coordinate data indicating the location of the object.

### 1-2-3. Characteristic Features of Individual Methods

The optical flow method mentioned above is capable of detecting an object from small motions of the feature points of the object. Therefore, the method is capable of detecting an object locating farther as compared to the template matching method. Moreover, the optical flow method is capable of detecting a various types of objects because the method does not require template images. Therefore, the method does not require database and the like for the template images. Furthermore, since the optical flow method does not need the scan of an image, the method has an advantageous feature that an object can be detected by a relatively small amount of calculation.

However, the optical flow method has a disadvantage that it becomes difficult to detect an object as a vehicle speed of the host vehicle is greater, because the optical flow method depends on the traveling state of the host vehicle.

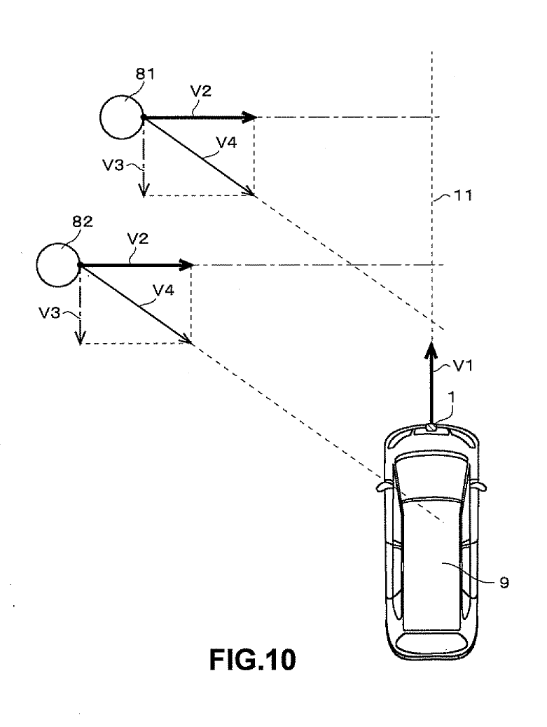

FIG. 10 shows relations between the host vehicle 9 and objects 81 and 82 moving in a vicinity of the host vehicle. In FIG. 10, the objects 81 and 82 are approaching the host vehicle 9, and the objects 81 and 82 are moving at a same velocity vector V2 in a right direction in FIG. 10. As mentioned above, only the inward-moving optical flow is extracted in the optical flow method to detect an object approaching the host vehicle 9. An optical flow of an object moves inward when a relative velocity vector thereof relative to the host vehicle 9 intersects the optical axis 11 of the vehicle-mounted camera 1.

When the host vehicle 9 is stopping, relative velocity vectors of the objects 81 and 82, relative to the host vehicle 9, are the velocity vector V2 itself of the objects 81 and 82. Since each of the velocity vector V2 of the objects 81 and 82 intersects the optical axis 11 of the vehicle-mounted camera 1, the optical flows of the objects 81 and 82 move inward. Therefore, both objects 81 and 82 can be detected.

Next, when the host vehicle 9 is traveling at a velocity vector V1, the relative velocity vector of each of the objects 81 and 82, relative to the host vehicle 9, is a resultant vector V4 derived by adding the velocity vector V2 of each of the objects 81 and 82 to an opposite vector V3 opposite to the velocity vector V1 of the host vehicle 9. The resultant vector V4 of the object 81 locating in a higher position in FIG. 10 intersects the optical axis 11 of the vehicle-mounted camera 1. Thus the object 81 can be detected. However, the resultant vector V4 of the object 82 locating in a lower position in FIG. 10 does not intersect the optical axis 11 of the vehicle-mounted camera 1. Thus the object 82 cannot be detected.

As mentioned above, when the host vehicle 9 is traveling, there is a case where the optical flow method becomes incapable of detecting an object that should be detected. The greater the velocity vector V1 of the host vehicle 9, the more difficult the optical flow method detects the object since the resultant vector V4 of the object moves in a more downward direction in FIG. 10. As mentioned above, it becomes more difficult to detect the object in the optical flow method on a condition where, for example, the host vehicle 9 travels relatively fast.

In contrast to the optical flow method, the template matching method has an advantage that the method is capable of detecting an object without depending on the traveling state of the host vehicle 9 because the method detects the object based on one captured image (frame).

However, on the other hand, since the template matching method is capable of detecting only an object having a particular level of size, the method cannot detect the object locating farther as compared to the optical flow method. Moreover, the template matching method is capable of detecting only objects in categories of which template images are prepared and is not capable of detecting an unexpected object. Furthermore, since the template matching method needs the scan an image for each prepared template image, the method has a disadvantage that a relatively large amount of calculation is needed.

The object detector 22 of the object detection system 10 in this embodiment uses both of the optical flow method and the template matching method in combination to compensate for the disadvantages of these methods.

Concretely, the method controller 22d determines, based on the vehicle speed signal input from the outside, whether the host vehicle is traveling or stopping. When the host vehicle is stopping, the method controller 22d enables the first detector 22a. When the host vehicle is traveling, the method controller 22d enables the second detector 22b. Thus when the host vehicle is stopping, an object is detected by the optical flow method. When the host vehicle is traveling during which it is difficult to detect an object by the optical flow method, the object is detected by the template matching method.

An image indicating an actual external appearance of the object derived from the detection result detected by the optical flow method is used as the template image used in the template matching method. Thus various types of objects can be detected without preparing for template images beforehand.

### 1-3. Object Detection Process

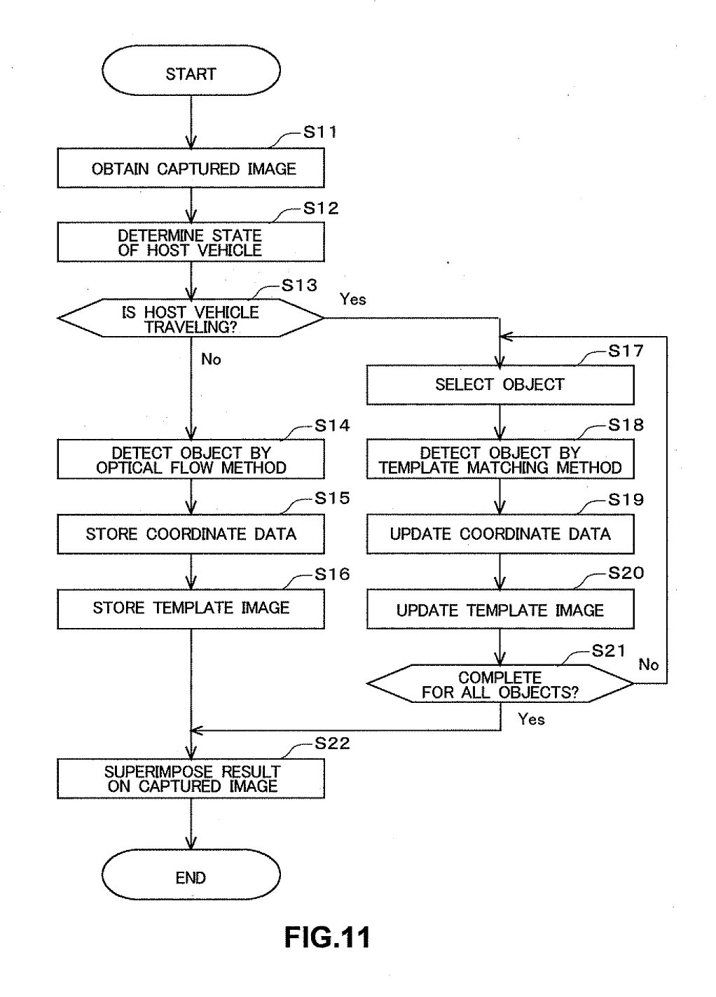

FIG. 11 is a flowchart illustrating an object detection process implemented by the image processor 2 to detect an object. This object detection process is repeatedly implemented by the image processor 2 in a predetermined cycle (e.g. 1/30 sec.). Thus the plurality of captured images obtained continuously in time by the image obtaining part 21 are processed in order. A procedure of the object detection process is hereinafter explained with reference to FIG. 3 and FIG. 11.

First the image obtaining part 21 obtains, from the vehicle-mounted camera 1, one captured image (frame) showing an area in front of the host vehicle (a step S11). After that, a process for detecting an object is implemented by using this captured image.

Next, the method controller 22d of the object detector 22 determines whether the host vehicle is traveling or stopping (a step S 12). The method controller 22d receives the vehicle speed signal from the vehicle speed sensor 7 and determines whether the host vehicle is traveling or stopping based on the vehicle speed of the host vehicle indicated by the received vehicle speed signal. The method controller 22d determines that the host vehicle is stopping when the vehicle speed is below a threshold speed and determines that the host vehicle is traveling when the vehicle speed is at or above the threshold speed.

When the host vehicle is stopping (No in a step S13), the method controller 22d enables the first detector 22a. Thus the first detector 22a detects an object by the optical flow method (a step S14).

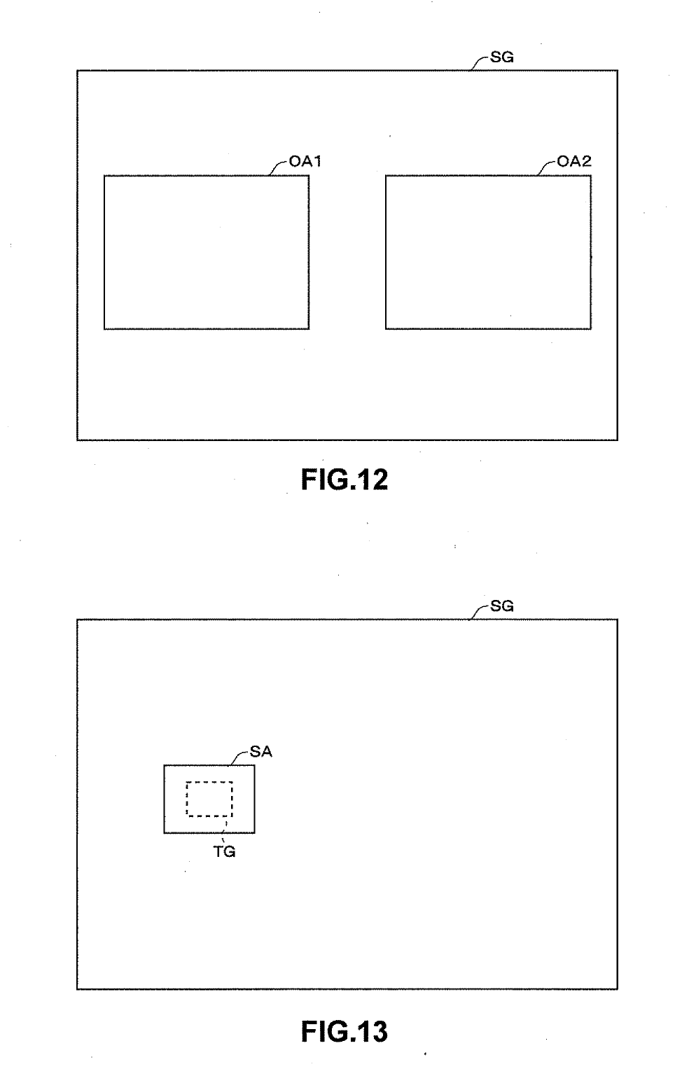

As shown in FIG. 12, the first detector 22a sets a detection area OA1 and a detection area OA2 at predetermined locations of a right side and a left side of the captured image SG respectively. Then the first detector 22a derives optical flows of the feature points in the detection area OA1 and the detection area OA2, based on the feature points in a most recently obtained captured image and the feature points in a preceding captured image that has been processed in the object detection process. The first detector 22a detects an object based on the right-pointing (inward) optical flow in the left side detection area OA1 and based on the left-pointing (inward) optical flow in the right side detection area OA2.

When having detected the object in such a process, the first detector 22a causes the memory 24 to store coordinate data of the detected object (a step S15). Moreover, the first detector 22a clips an area relating to the detected object, as an image, from most recently obtained one captured image among the plurality of captured images that have been processed by the optical flow method. The first detector 22a causes the clipped image to be stored in the memory 24 (a step S16). For example, the first detector 22a clips an area of a group of the optical flows used for detecting the object, as the image.

The image stored in the memory 24 in such a manner includes an object image showing an actual external appearance of the object and is used as the template image (reference image). The coordinate data and the template image of the detected object are used as object data OD of the detected object. When having detected plural objects, the first detector 22a causes the memory 24 to store the object data OD (the coordinate data and the template image) of each of the detected plural objects. Next, the process moves to a step S22.

On the other hand, when the host vehicle is traveling (Yes in the step S13), the method controller 22d enables the second detector 22b. Thus the second detector 22b detects an object by the template matching method.

The second detector 22b first reads out the object data OD (the coordinate data and the template image) of the object stored in the memory 24. Then, when the object data OD relating to the plural objects is stored, the second detector 22b selects one from amongst the plural objects to be processed (a step S17).

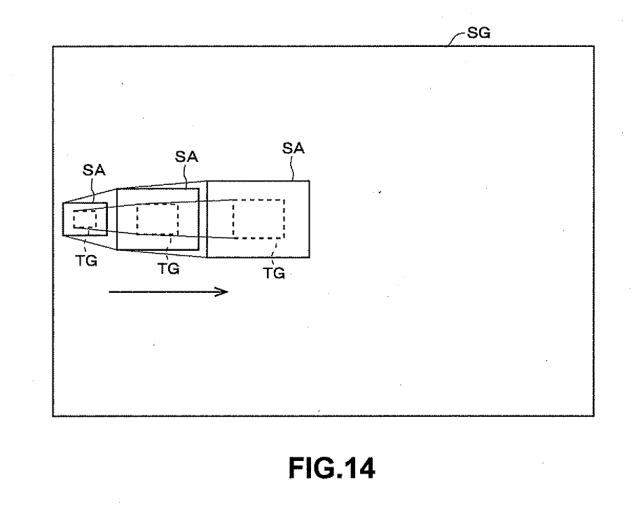

Next, the second detector 22b detects the object by the template matching method by using the object data OD (the coordinate data and the template image) of the selected object (a step S18). As shown in FIG. 13, the second detector 22b sets the search range SA including an area corresponding to a location of the template image TG and a vicinity of the area in the captured image SG that has been most recently obtained. The second detector 22b sets the search range SA based on the coordinate data of the selected object. In FIG. 13, the reference numeral TG is assigned to the area corresponding to the location of the template image TG (same as in FIG. 14 mentioned later).

A height and a wide of the search range SA are, for example, two times of a height and a width of the template image TG. A center of the search range SA is fitted to a center of the area corresponding to the location of the template image TG The second detector 22b scans the search range SA with reference to the template image TG to detect an. object by searching for the correlation area having a correlation with the template image TG.

When having detected the object in such a process, the second detector 22b updates the object data OD of the object stored in the memory 24. In other words, the second detector 22b updates the coordinate data stored in the memory 24 by using the coordinate data of the detected object (a step S19). Moreover, the second detector 22b clips an area relating to the detected object, as an image, from the captured image that has been processed by the template matching method. The second detector 22b updates the template image stored in the memory 24 by using the clipped image (a step S20). For example, the second detector 22b clips the correlation area searched for detecting the object, as an image.

When the coordinate data of the object detected by the template matching method is the substantially same as the coordinate data of the object stored in the memory 24, the update of the object data OD (the coordinate data and the template image) of the object may be omitted.

The second detector 22b implements the process for detecting the object (from the step S17 to the step S20) by the template matching method for each object of which object data OD is stored in the memory 24. When the process is complete for all the objects (Yes in a step S21), the process moves to the step S22.

In the step S22, the result superimposing part 22c superimposes the detection result of the object detected by the first detector 22a or the second detector 22b, on the captured image for display. The result superimposing part 22c reads out the object data OD stored in the memory 24, and recognizes the location of the object image of the object, based on the coordinate data. Then the result superimposing part 22c superimposes the mark indicating a left direction on the captured image when the object image is located in the left side of the captured image, and the mark indicating a right direction on the captured image when the object image is located in the right side of the captured image. The captured image superimposed with the mark, as mentioned above, is output to the displaying apparatus 3 from the image output part 23 and is displayed on the displaying apparatus 3.

As mentioned above, in the object detection system 10, the image obtaining part 21 obtains, continuously in time, captured images of the vicinity of the host vehicle captured by the vehicle-mounted camera 1. The first detector 22a detects the object by using the plurality of captured images (frames) each of which has been obtained at a different time point. At the same time the first detector 22a stores in the memory 24 the area relating to the detected object in one of the plurality of captured images that has been processed, as the template image. Then the second detector 22b detects the object by using and searching one captured image for a correlation area having a correlation with the template image.

Since the first detector 22a detects an object by the optical flow method, the object can be detected utilizing the advantages of the optical flow method mentioned above. In addition, since the second detector 22b detects the object by the template matching method by using the area relating to the object detected by the optical flow method as the template image, the object can be detected even under a situation where it is difficult to detect the object by the optical flow method. Moreover, since the template image shows the actual external appearance of the object, the template image does not have to be prepared beforehand and various types of objects including an unexpected object can be detected. Furthermore, only one template image exists for one object. Therefore, the object can be detected by a relatively small amount of calculation even in the template matching method.

In addition, the method controller 22d enables one of the first detector 22a and the second detector 22b selectively in accordance with the traveling state of the host vehicle. In other words, the method controller 22d enables the first detector 22a when the host vehicle 9 is stopping, and enables the second detector 22b when the host vehicle is traveling. As mentioned above, since the second detector 22b is enabled when the host vehicle is traveling, an object can be detected even when the host vehicle is traveling where it is difficult for the first detector 22a to detect an object by the optical flow method.

Moreover, the second detector 22b detects an object by searching the search range SA including the area corresponding to the location of the template image in the captured image and the vicinity of the area, for the correlation area. Therefore, a calculation amount can be reduced to detect the object as compared to searching the whole captured image.

### 2. Second Embodiment

Next, a second embodiment is explained. A configuration and a process of an object detection system 10 in the second embodiment are the substantially same as the configuration and the process in the first embodiment. Therefore, points different from the first embodiment are mainly hereinafter explained.

In the first embodiment, the sizes of the template image and the search range for a same object are kept constant. Contrarily, in the second embodiment, the sizes of the template image and the search range for a same object are changed in accordance with time required for the process implemented for the same object.

As shown in FIG. 4 to FIG. 6, a size of an object image T showing a same object approaching a host vehicle becomes larger as time progresses. Therefore, a second detector 22b in the second embodiment increases the sizes of a template image TG and a search range SA, as shown in FIG. 14, in accordance with time required for the process implemented for the same object. Thus, the object approaching the host vehicle can be detected accurately because a process for detecting an object can be implemented by a template matching method in response to an increased size of the object image T.

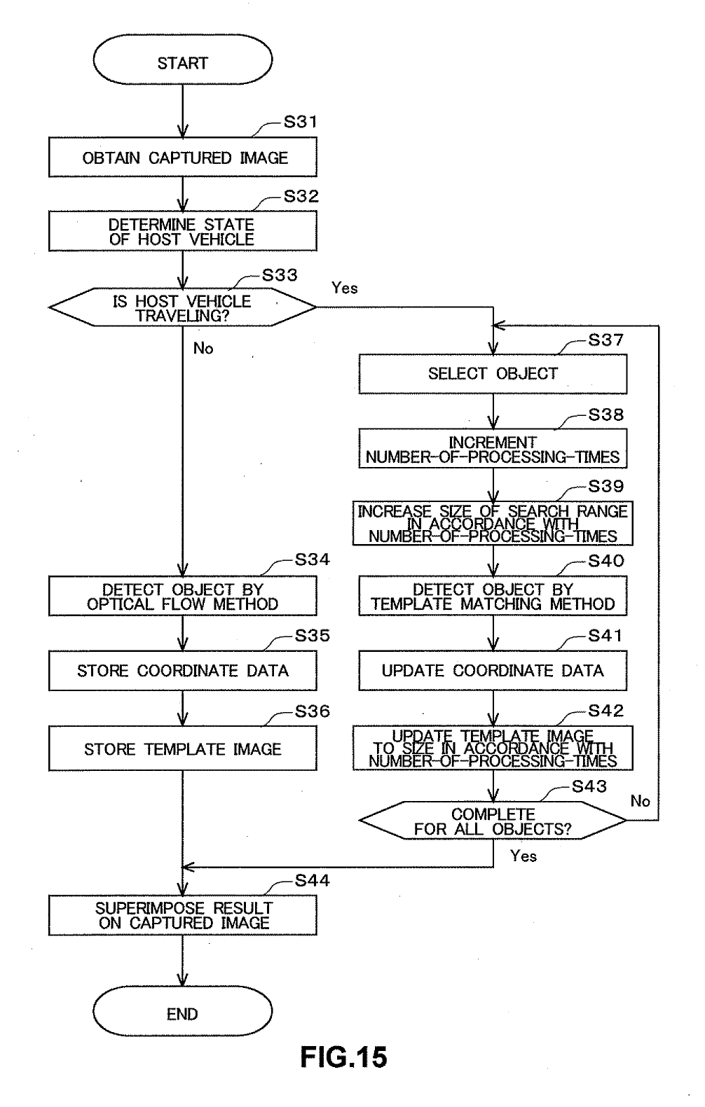

FIG. 15 is a flowchart illustrating the object detection process in which an image processor 2 in the second embodiment detects an object. The object detection process is repeatedly implemented by the image processor 2 in a predetermined cycle (e.g. 1/30 sec.). With reference to FIG. 15, a procedure of the object detection process in the second embodiment is hereinafter explained.

The process from steps S31 to S36 is the same as the process from the steps S11 to S16 shown in FIG. 11. In other words, an image obtaining part 21 obtains one captured image (frame) (the step S31), and a method controller 22d determines a traveling state of the host vehicle (the step S32). When the host vehicle is stopping (No in the step S33), a first detector 22a detects an object by an optical flow method (the step S34). When having detected objects, the first detector 22a causes a memory 24 to store object data OD of each of the detected objects (the steps S35 and S36). Next, the process moves to a step S44.

On the other hand, when the host vehicle is traveling (Yes in the step S33), the second detector 22b reads out the object data OD (coordinate data and the template images) stored in the memory 24. When the object data OD of plural objects is stored, the second detector 22b selects one target object to be processed, from amongst the plural objects (a step S37).

Next, the second detector 22b increments a number-of-processing-times N for the selected target object (a step S38). The second detector 22b manages the number-of-processing-times N for each of the processed target object, by storing the number-of-processing-times Nin an internal memory or the like. Then the second detector 22b adds one to the number-of-processing-times N of the target object (N=N+1) every time when implementing the object detection process to the target object. Since the object detection process is repeated in the predetermined cycle, the number-of-processing-times N corresponds to the time required for the process that the second detector 22b implements for the target object.

Next, the second detector 22b sets the search range SA in the captured image. At the same time, the second detector 22b increases a size of the search range SA for the object detection process this time than for a preceding object detection process, in accordance with the number-of-processing-times N (a step S39). An increase percentage for the size of the search range SA is determined in accordance with a predetermined function taking the number-of-processing-times N as a variable. Such a function is determined beforehand based on a general motion of an object approaching the host vehicle at a predetermined speed (e.g. 30 km/h).

Next, the second detector 22b scans the search range SA with reference to the template image TG to detect an object by searching for a correlation area having a correlation with the template image TG (a step S40).

When having detected the object in such a process, the second detector 22b updates the object data OD of the object stored in the memory 24. In other words, the second detector 22b updates the coordinate data stored in the memory 24 by using the coordinate data of the detected object (a step S41).

Moreover, the second detector 22b updates the template image TG stored in the memory 24 by using an area relating to the detected object in the captured image. At the same time, the second detector 22b increases a size of the template image TG for the object detection process this time than for a preceding object detection process, in accordance with the number-of-processing-times N (a step S42). An increase percentage for the size of the template image TG is determined in accordance with a predetermined function taking the number-of-processing-times N as a variable. Such a function is determined beforehand based on the general motion of the object approaching the host vehicle at the predetermined speed (e.g. 30 km/h).

The second detector 22b implements such an object detection process (from the step S37 to the step 842) for each object of which object data OD is stored in the memory 24. Thus the object detection process is implemented by the template matching method by using the template image TG and the search range SA of which sizes are determined in accordance with the number-of-processing-times N for each object. When the process is complete for all the objects (Yes in a step S43), the process moves to the step S44.

In the step S44, a result superimposing part 22c superimposes a detection result of the object detected by the first detector 22a or the second detector 22b, on the captured image for display.

As mentioned above, the second detector 22b in the second embodiment increases the size of the search range SA for a same object, in accordance with the time required for the process implemented for the same object. Thus the object approaching the host vehicle can be accurately detected.

Moreover, the second detector 22b increases the size of the template image for a same object, in accordance with the time required for the process implemented for the same object.

Thus the object approaching the host vehicle can be accurately detected.

### 3. Third Embodiment

Next, a third embodiment is explained. A configuration and a process of an object detection system 10 in the third embodiment are the substantially same as the configuration and the process in the first embodiment. Therefore, points different from the first embodiment are mainly hereinafter explained.

In the first embodiment, when the host vehicle is traveling, an object is detected by the template matching method. However, it is possible to detect an object by the optical flow method even when the host vehicle is traveling, although detection accuracy decreases. As mentioned above, the optical flow method has the advantages, for example, that an object can be detected by a relatively small amount of calculation as compared to the template matching method. Therefore, in the third embodiment, an optical flow method is used to detect an object, in principle. Only in a case where the optical flow method cannot detect an object, the object is detected by a template matching method.

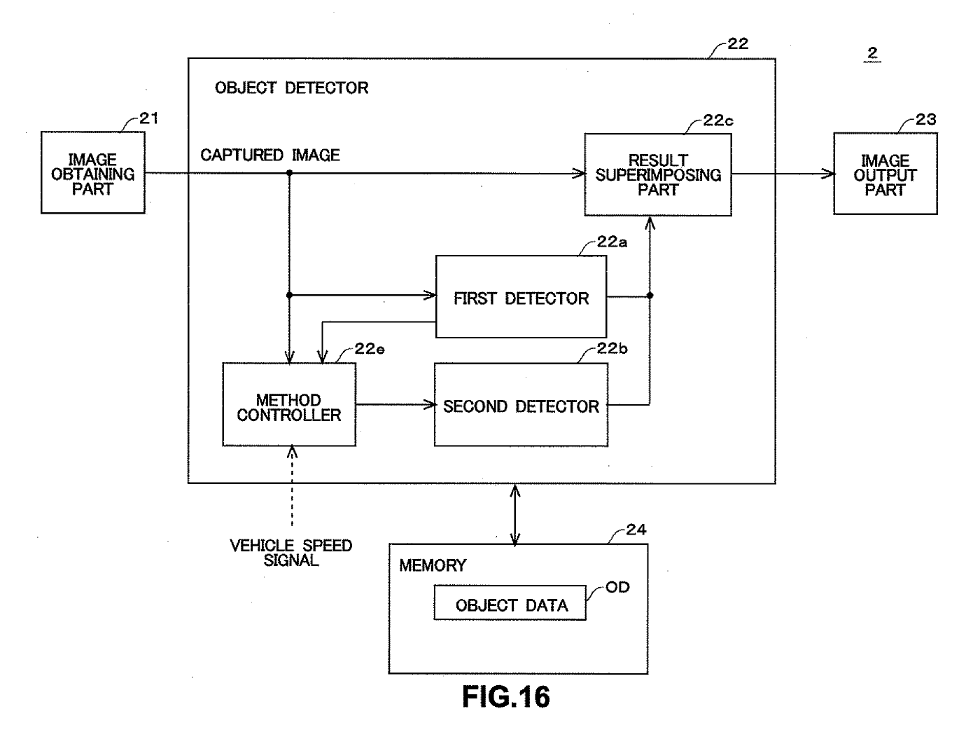

FIG. 16 is a detailed diagram illustrating a configuration of an object detector 22 in the third embodiment. The object detector 22 in the third embodiment includes a method controller 22e instead of the method controller 22d in the first embodiment. The method controller 22e enables a second detector 22b when a predetermined condition is satisfied.

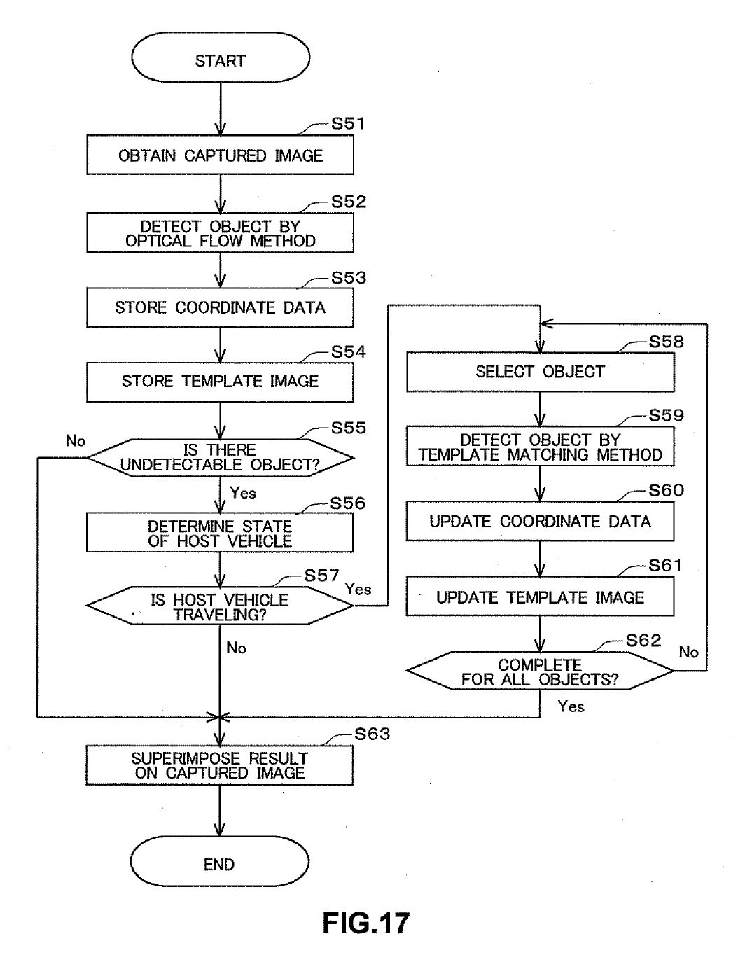

FIG. 17 is a flowchart illustrating an object detection process in the third embodiment. This object detection process is repeatedly implemented by an image processor 2 in a predetermined cycle (e.g. 1/30 sec.). A procedure of the object detection process in the third embodiment is hereinafter explained with reference to FIG. 16 and FIG. 17.

First an image obtaining part 21 obtains, from a vehicle-mounted camera 1, one captured image (frame) showing an area in front of a host vehicle (a step S51). After that, a process for detecting an object by using this captured image is implemented.

Next, a first detector 22a detects an object by the optical flow method (a step S52). When having detected objects, the first detector 22a causes a memory 24 to store object data OD (coordinate data and a template image) of each of the detected objects (steps S53 and S54).

Next, the method controller 22e causes each of the objects detected by the first detector 22a in current object detection process to correspond to a corresponding object thereof detected in a preceding object detection process. The object data OD of the objects detected in the preceding object detection process is stored in the memory 24. Each of the detected objects detected in the current process is caused to correspond to the corresponding object thereof detected in the preceding object detection process, referring to coordinate data and based on a mutual positional relation. Then the method controller 22e determines whether among the objects detected in the preceding object detection process, there is an object that has not been caused to correspond to any object detected in the current object detection process. In other words, the method controller 22e determines whether the objects detected in a past object detection process have been detected by the first detector 22a in the current object detection process. When all the objects detected in the past object detection process have been detected in the current object detection process by the first detector 22a (No in a step S55), the process moves to a step S63.

Moreover, when one or more of the objects detected in the past object detection process have not been detected in the current object detection process by the first detector 22a (Yes in the step S55), the method controller 22d determines whether the host vehicle is traveling or stopping, based on a vehicle speed signal from a vehicle speed sensor 7 (a step S56). When the host vehicle is stopping (No in a step S57), the object not being detected in the current object detection process (hereinafter referred to as “missing object”) has not been detected regardless of a traveling state of the host vehicle. Therefore, the process moves to the step S63.

On the other hand, when the host vehicle is traveling (Yes in the step S57), there is a possibility that the missing object has become undetectable by the optical flow method implemented by the first detector 22a due to traveling of the host vehicle. Therefore, the method controller 22e enables the second detector 22b. Thus the second detector 22b implements the object detection process to detect the missing object by the template matching method.

The second detector 22b first reads out the object data OD (the coordinate data and the template image) of the missing object stored in the memory 24. If there are plural missing objects, the second detector 22b selects one object to be processed from amongst the plural missing objects (a step S58).

Next, by using the object data OD (the coordinate data and the template image) of the selected missing object, the second detector 22b implements a process for detecting the missing object in the template matching method (a step S59). When having detected the missing object by this process, the second detector 22b updates the object data OD stored in the memory 24 for the detected object. In other words, the second detector 22b updates the coordinate data and the template image stored in the memory 24 for the missing object (steps S60 and S61).

The second detector 22b implements the process mentioned above to detect each of the missing objects by the template matching method (the steps S58 to S61). When the process is complete for all the missing objects (Yes in a step S62), the process moves to the step S63.

In the step S63, a result superimposing part 22c superimposes detection results detected by the first detector 22a and the second detector 22b on the captured image for display.

As mentioned above, in the third embodiment, when the first detector 22a has failed to detect an object detected in a past object detection process, the second detector 22bimplements the process for detecting the object that has not been detected by the first detector 22a. In other words, the object detection system 10 in the third embodiment implements the process for detecting an object by the template matching method, when the object has not been detected by the optical flow method. Therefore, even when having become unable to detect an object by the optical flow method, the object detection system 10 is capable of detecting the object.

Moreover, in a case where the first detector 22a has failed to detect an object detected in the past object detection process and where the host vehicle is traveling, the second detector 22b implements a process for detecting the object. Therefore, the object detection system 10 is capable of detecting the object that has become undetectable by the optical flow method due to the traveling of the host vehicle.

### 4. Modifications

As mentioned above, some embodiments of the invention are explained. However, the invention is not limited to the embodiments described above, but various modifications are possible. Some of the modifications are hereinafter explained. All forms including the embodiments mentioned above and the modifications below may be optionally combined.

In the first and the second embodiments, one of the first detector 22a and the second detector 22b is enabled in accordance with traveling or stopping of the host vehicle. On the other hand, one of the first detector 22a and the second detector 22b may be enabled based on a speed of the host vehicle. Concretely, the method controller 22d enables the first detector 22a when the speed of the host vehicle is slower than a predetermined threshold (e.g. 10 km/h). The method controller 22d enables the second detector 22b when the speed of the host vehicle is equal to or faster than the predetermined threshold.

Moreover, in the third embodiment, when the host vehicle is traveling, the second detector 22b is enabled. However, the second detector 22b may be enabled when the speed of the host vehicle is equal to or faster than a predetermined threshold (e.g. 10 km/h).

Furthermore, in the embodiments mentioned above, the first detector 22a detects an object by the optical flow method. On the other hand, the first detector 22a may detect an object by another frame correlation method such as inter-frame difference method. The inter-frame difference method calculates and obtains differences of pixel values by comparing two captured images obtained at two different time points, and detects an object based on an area in which the pixel values are different between the two captured images. In case of adopting the inter-frame difference method, the process may be implemented only for an area corresponding to a road in the captured image.

Moreover, in the second embodiment, the sizes of the template image and the search range of a same object are increased, in accordance with the time required for the process implemented for the same object. However, it is not limited to the size increase. In other words, the sizes of the template image and the search range may be changed in accordance with a motion of a same object moving relatively to the host vehicle. For example, when detecting an object moving away from the host vehicle, the sizes of the template image and the search range for the same object may be reduced in accordance with time required for the process implemented for the same object.

Furthermore, in the embodiments mentioned above, the vehicle-mounted camera 1 is explained as a front camera that captures images of an area in front of the host vehicle 9. On the other hand, the vehicle-mounted camera 1 may be a rear camera that captures images of a rear area of the host vehicle 9, or may be a side camera that captures images of a side area of the host vehicle 9.

In addition, in the embodiments mentioned above, the mark that indicates the direction in which the object exists is superimposed, as the detection result, on the captured image. However, an image of a detected object may be emphasized by using a mark.

Moreover, a part of the functions that are implemented by hardware circuits in the embodiments mentioned above may be implemented by software.

While the invention has been shown and described in detail, the foregoing description is in all aspects illustrative and not restrictive. It is therefore understood that numerous other modifications and variations can be devised without departing from the scope of the invention.

What is claimed is:

1. An object detection apparatus that detects an object moving in a vicinity of a vehicle, the apparatus comprising:
an obtaining part that obtains a captured image of the vicinity of the vehicle;
a first detector that detects the object by using a plurality of the captured images obtained by the obtaining part at different time points;
a memory that stores, as a reference image, an area relating to the object detected by the first detector and included in one of the plurality of captured images that have been used by the first detector; and
a second detector that detects the object by searching for a correlation area, having a correlation with the reference image, included in a single captured image obtained by the obtaining part.

2. The object detection apparatus according to claim 1, further comprising:
a controller that selectively enables one of the first detector and the second detector in accordance with a state of the vehicle.

3. The object detection apparatus according to claim 2, wherein
the controller enables:
the first detector when a speed of the vehicle is below a threshold speed; and
the second detector when the speed of the vehicle is at or above the threshold speed.

4. The object detection apparatus according to claim 1, wherein
the second detector searches for the correlation area in a search range including an area corresponding to an area of the reference image and in a vicinity of the area corresponding to the area of the reference image included in the captured image obtained by the obtaining part.

5. The object detection apparatus according to claim 4, wherein
the second detector changes a size of the search range for a same object, in accordance with time required for a process implemented for the same object.

6. The object detection apparatus according to claim 1, wherein
the second detector changes a size of the reference image for a same object, in accordance with time required for a process implemented for the same object.

7. The object detection apparatus according to claim 1, wherein
when the first detector cannot detect the object detected in a past process, the second detector implements a process for detecting the object.

8. The object detection apparatus according to claim 7, wherein
when the first detector cannot detect the object detected in the past process and also when the vehicle is traveling, the second detector implements the process for detecting the object.

9. The object detection apparatus according to claim 1, wherein
the first detector detects the object using a frame correlation method, and
the second detector detects the object using a template matching method.

10. An object detection method that detects an object moving in a vicinity of a vehicle, comprising the steps of:
(a) obtaining a captured image of the vicinity of the vehicle;
(b) detecting the object by using a plurality of the captured images obtained by the step (a) at different time points;
(c) storing, as a reference image, an area relating to the object detected by the step (b) and included in one of the plurality of captured images that have been used by the step (b); and
(d) detecting the object by searching for a correlation area, having a correlation with the reference image, included in a single captured image obtained by the step (a).

11. The object detection method according to claim 10, further comprising the step of
(e) selectively enabling one of the step (b) and the step (d) in accordance with a state of the vehicle.

12. The object detection method according to claim 11, wherein
the step (e) enables:
the step (b) when a speed of the vehicle is below a threshold speed; and
the step (d) when the speed of the vehicle is at or above the threshold speed.

13. The object detection method according to claim 10, wherein
the step (d) searches for the correlation area in a search range including an area corresponding to an area of the reference image and in a vicinity of the area corresponding to the area of the reference image included in the captured image obtained by the step (a).

14. The object detection method according to claim 13, wherein
the step (d) changes a size of the search range for a same object, in accordance with time required for a process implemented for the same object.

15. The object detection method according to claim 10, wherein
the step (d) changes a size of the reference image for a same object, in accordance with time required for a process implemented for the same object.

16. The object detection method according to claim 10, wherein
when the step (b) cannot detect the object detected in a past process, the step (d) is implemented.

17. The object detection method according to claim 16, wherein
when the step (b) cannot detect the object detected in the past process and also when the vehicle is traveling, the step (d) is implemented.

18. The object detection method according to claim 10, wherein
the step (b) detects the object using a frame correlation method, and
the step (d) detects the object using a template matching method.
